(19) United States
(12) Patent Application Publication
(10) Pub. No.: US 2013/0182374 A1
(43) Pub. Date: Jul. 18, 2013

(54) SOLID ELECTROLYTIC CAPACITOR AND METHOD FOR PRODUCING THE SAME

(71) Applicant: NEC TOKIN Corporation, Sandai-shi (JP)

(72) Inventors: Takashi MIZUKOSHI, Sendai-shi (JP); Koji SAKATA, Sendai-shi (JP)

(73) Assignee: NEC TOKIN Corporation, Sendai-shi (JP)

(21) Appl. No.: 13/718,669

(22) Filed: Dec. 18, 2012

(30) Foreign Application Priority Data
Dec. 21, 2011 (JP) 2011-280028

(51) Int. Cl. H01G 9/00; H01G 9/048

(52) U.S. Cl. CPC H01G 9/0029; H01G 9/048
USPC 361/528; 29/25.03

(57) ABSTRACT

The present invention provides a solid electrolytic capacitor and a method for producing the same, in which the anode portion is hard to be cut off and the reliability can be improved when the ultrasonic welding is carried out, and in which the volumetric efficiency is improved. The present invention is solid electrolytic capacitor 15, in which capacitor elements 11 are laminated, in which anode portion 5 and cathode portion 4 are electrically connected to anode terminal 17 and cathode terminal 18, respectively, and wherein solid electrolytic capacitor 15 includes outer packaging 10 of an insulating material with which a whole area is covered, as well as in which anode portion 5 includes welded portion 12 at a terminal portion thereof which is connected to anode terminal 17 and includes bundled portion 13 which bundles a part of anode portion 5 between welded portion 12 and insulating portion 3.

This application is based upon and claims the benefit of priority from Japanese patent application No. 2011-280028, filed on Dec. 21, 2011, the disclosure of which is incorporated herein in its entirety by reference.

### BACKGROUND OF THE INVENTION

1. Field of the Invention

The present invention relates to a solid electrolytic capacitor and a method for producing the same.

2. Description of the Related Art

Conventionally, since solid electrolytic capacitors using a valve action metal such as tantalum or niobium have a small size, a large electrostatic capacitance and an excellent frequency characteristic, they are widely used for a switching power circuit of a device such as CPU, which works with high-speed.

In late years, in particular, with the development of portable electronic devices, solid electrolytic capacitors come to be smaller and thinner. Further, for cost reduction, solid electrolytic capacitors in which plural capacitor elements using a foil or a plate of an etched aluminum are laminated are used.

Here, an example of a structure of a solid electrolytic capacitor is explained. FIG. 6 is a schematic cross-sectional view explaining a configuration of a conventional solid electrolytic capacitor.

As shown in FIG. 6, anode element body 31 includes a tabular aluminum foil having porous layer 32 on a surface of which a dielectric layer (not shown) is provided, or the like. Insulating portion 33 containing an insulating resin is provided on a part of a surface of anode element body 31 in a band state, by which cathode portion 34 and anode portion 35 are separated. In cathode portion 34, solid electrolyte layer 36, graphite layer 37 and silver paste layer 38 are formed in this order on the surface of the dielectric layer. Anode portion 35 includes a metal core portion of aluminum in which porous layer 32 is removed. Capacitor elements 41 including anode portion 35 and cathode portion 34 separated by insulating portion 33 are connected to each other with electroconductive adhesive 39 and laminated.

Further, anode portions 35 laminated are electrically connected to anode terminal 42 that is an electrode terminal by a welding or the like, and cathode portions 34 laminated are similarly connected to cathode terminal 43 that is an electrode terminal with electroconductive adhesive 39. After that, they are covered with outer packaging 40 containing an epoxy resin or the like to obtain laminated-type solid electrolytic capacitor 45.

For improving a yield of the product in the solid electrolytic capacitor, it is important to make a good connection of the anode portion to the anode terminal, and various studies regarding the welding are carried out.

JP 2004-87893 A proposes a technology in which, when anode portions of plural capacitor elements including an aluminum foil are connected to an anode terminal, the anode portion is connected to an anode terminal having a through-hole by a resistance welding, in order to suppress the increase of equivalent series resistance (ESR) in a solid electrolytic capacitor. The structure provides effects of improving the strength of welding and of decreasing ESR by concentrating current on the through-hole in the case in which the connection is carried out by using a resistance welding.

Also, JP 2005-217073 A proposes a technology in which a layer obtained by compressing a porous layer having an oxide film layer is formed in an anode portion and the connection is carried out by a laser welding, in order to suppress a break in the anode portion of the capacitor element including an aluminum foil in a solid electrolytic capacitor and a method for producing the same.

The welding method for connecting metal foils includes an ultrasonic welding along with the resistance welding and the laser welding. When a metal foil such as an aluminum foil are electrically connected, the ultrasonic welding is effective because the connectivity is better as compared with the resistance welding even if a portion having a high electroconductivity remains, and because the welded portion is not excessively melted and the improvement of the reliability is anticipated as compared with the laser welding. Thus, there is a study to use the ultrasonic welding for connecting the anode portion to the anode terminal in the solid electrolytic capacitor.

However, in the structure of JP 2004-87893 A, when the ultrasonic welding is carried out, there is a problem that the anode portion is possibly cut off by the vibration of the ultrasonic which reaches the boundary portion of the anode portion and the insulating portion.

Also, in the structure of JP 2005-217073 A, when the ultrasonic welding is carried out, there is a problem that the anode portion is easily cut off by the vibration of the ultrasonic which reaches the anode portion except for the welded portion.

Thus, the present invention is realized in order to solve the above-mentioned problem, and the object is to provide a solid electrolytic capacitor and a method for producing the same, in which the anode portion is hard to be cut off and the reliability can be improved.

### SUMMARY OF THE INVENTION

The present invention is a solid electrolytic capacitor, in which capacitor elements are laminated, in which an anode portion and a cathode portion are electrically connected to an anode terminal and a cathode terminal, respectively, and in which the solid electrolytic capacitor includes an outer packaging of an insulating material with which a whole area is covered, as well as in which the anode portion includes a welded portion at a terminal portion thereof which is connected to the anode terminal and includes a bundled portion which bundles a part of the anode portion between the welded portion and the insulating portion.

Also, the present invention includes bending a part of the anode portion between the welded portion and the insulating portion in a laminating direction, gripping the part of the anode portion in the laminating direction by using a gripping member to form a bundled portion, and connecting the welded portion to the anode terminal by an ultrasonic welding in a state of gripping the part of the anode portion.

That is, the solid electrolytic capacitor according to the present invention includes plural capacitor elements which are laminated, in each of which an anode portion and a cathode portion are separated by an insulating portion, wherein the cathode portion is formed by forming a dielectric layer on a surface of a tabular valve action metal having a porous layer and by forming a solid electrolyte layer, a graphite layer and a silver paste layer in this order on a surface of the dielectric layer, and wherein the anode portion is formed by removing the dielectric layer and the porous layer, and wherein the anode portion and the cathode portion are electrically connected to an anode terminal and a cathode terminal, respectively, and wherein the solid electrolytic capacitor includes an outer packaging of an insulating material with which a whole area is covered, wherein the anode portion includes a welded portion at a terminal portion thereof which is connected to the anode terminal and includes a bundled portion which bundles a part of the anode portion between the welded portion and the insulating portion.

Also, in the solid electrolytic capacitor according to the present invention, the bundled portion may be placed at a center in thickness direction of a laminated body in which the capacitor elements are laminated.

The method for producing a solid electrolytic capacitor according to the present invention includes laminating plural capacitor elements, in each of which an anode portion and a cathode portion are separated by an insulating portion, wherein the cathode portion is formed by forming a dielectric layer on a surface of a tabular valve action metal having a porous layer and by forming a solid electrolyte layer, a graphite layer and a silver paste layer in this order on a surface of the dielectric layer, and wherein the anode portion is formed by removing the dielectric layer and the porous layer; bending a part of the anode portion between the welded portion and the insulating portion in a laminating direction, wherein the anode portion includes a welded portion at a terminal portion thereof which is connected to the anode terminal; gripping the part of the anode portion in the laminating direction by using a gripping member to form a bundled portion; connecting the welded portion to the anode terminal by an ultrasonic welding in a state of gripping the part of the anode portion; connecting the cathode portion to the cathode terminal; and covering the laminated capacitor elements, the anode terminal and the cathode terminal with an insulating resin to provide an outer packaging.

Also, the method for producing a solid electrolytic capacitor according to the present invention may include placing the bundled portion at a center in thickness direction of a laminated body in which the capacitor elements are laminated.

Also, in the method for producing a solid electrolytic capacitor according to the present invention, the gripping member preferably includes an elastic member.

The present invention can provide a solid electrolytic capacitor, in which the anode portion is hard to be cut off and the reliability can be improved, by including a welded portion at a terminal portion in the anode portion which is connected to the anode terminal and by including a bundled portion which bundles a part of the anode portion between the welded portion and the insulating portion. The present invention can also provide a method for producing a solid electrolytic capacitor, in which the anode portion is hard to be cut off and the reliability can be improved, by including bending a part of the anode portion between the welded portion and the insulating portion in a laminating direction, gripping the part of the anode portion in the laminating direction by using a gripping member to form a bundled portion, and connecting the welded portion to the anode terminal by an ultrasonic welding in a state of gripping the part of the anode portion.

### BRIEF DESCRIPTION OF THE DRAWINGS

FIG. 1 is a schematic cross-sectional view explaining a configuration of the solid electrolytic capacitor of the present invention.

FIG. 2 is a schematic cross-sectional view explaining a state in which capacitor elements of the present invention are laminated.

FIG. 3 is a schematic cross-sectional view explaining a state in which a forming of the capacitor element of the present invention is carried out.

FIG. 4 is a schematic cross-sectional view explaining a state in which a part of an anode portion of the capacitor element of the present invention is gripped.

FIG. 5 is a schematic cross-sectional view explaining a state in which an ultrasonic welding is carried out in a state of gripping a part of an anode portion of the capacitor element of the present invention.

FIG. 6 is a schematic cross-sectional view explaining a configuration of a conventional solid electrolytic capacitor.

### DETAILED DESCRIPTION OF THE PREFERRED EMBODIMENTS

The embodiment of the present invention is explained with reference to the drawings.

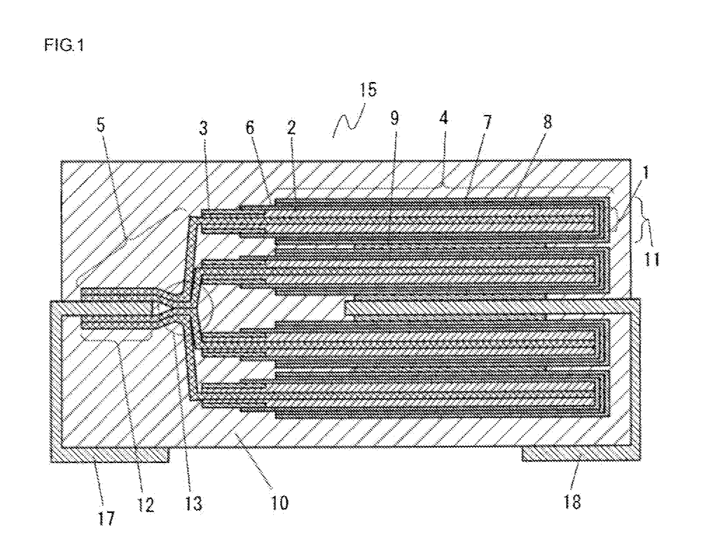

FIG. 1 is a schematic cross-sectional view explaining a configuration of the solid electrolytic capacitor of the present invention. As shown in FIG. 1, anode element body 1 includes a tabular aluminum foil having porous layer 2 on a surface of which a dielectric layer (not shown) is provided, or the like, which is the same structure as that of the conventional solid electrolytic capacitor. Insulating portion 3 containing an insulating resin is provided on a part of a surface of anode element body 1 in a band state, by which cathode portion 4 and anode portion 5 are separated. In cathode portion 4, solid electrolyte layer 6, graphite layer 7 and silver paste layer 8 are formed in this order on the surface of the dielectric layer. Anode portion 5 includes a metal core portion of aluminum in which porous layer 2 is removed. Capacitor elements 11 including anode portion 5 and cathode portion 4 separated by insulating portion 3 are connected to each other with electroconductive adhesive 9 and laminated.

Here, a part of anode portion 5 of the present invention is bent between insulating portion 3 and welded portion 12 that becomes a terminal portion of anode portion 5 and is bundled to provide bundled portion 13.

Also, the distance between welded portion 12 and insulating portion 3 can be decreased by bending a part of anode portion 5 between insulating portion 3 and welded portion 12 and bundling it. Thus, it is possible to enlarge the area of cathode portion 4 and to improve the volumetric efficiency of capacitor element 11.

Further, anode portions 5 laminated are electrically connected to anode terminal 17 that is an electrode terminal at welded portion 12 by an ultrasonic welding, and cathode portions 4 laminated are similarly connected to cathode terminal 18 that is an electrode terminal with electroconductive adhesive 9. After that, the capacitor elements laminated and the electrode terminals are covered with outer packaging 10 containing an epoxy resin or the like to obtain laminated-type solid electrolytic capacitor 15.

The valve action metal used for anode element body 1 is not limited to aluminum as long as it can be bent between insulating portion 3 and welded portion 12 that becomes a terminal portion of anode portion 5 and can electrically be connected by an ultrasonic welding.

Solid electrolyte layer 6 is constructed by manganese dioxide or by an electroconductive polymer such as polythiophene, polypyrrole and derivatives thereof. Since the electroconductive polymer such as polythiophene or polypyrrole can result in a high electroconductivity, solid electrolyte layer 6 is preferably constructed by the above-mentioned electroconductive polymer in the case in which lower ESR is necessary.

The formation of solid electrolyte layer 6 is carried out by using chemical oxidation polymerization method or electropolymerization method which is a well-known method. Also, a method by the immersion to an electroconductive polymer suspension in which the polymerized electroconductive polymer is preliminary dispersed to or dissolved in an aqueous solution can be adopted. Further, solid electrolyte layer 6 can be formed as plural electroconductive polymer layers by the combination of these methods.

### (Production Method)

Subsequently, the method for producing a solid electrolytic capacitor of the present invention is explained by using the drawings. In the production method of the present invention, since the step for obtaining a capacitor element can be carried out by a well-known method, the explanation thereof is omitted.

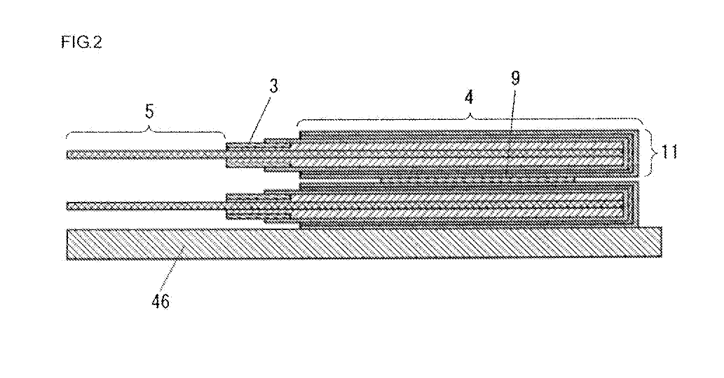

FIG. 2 is a schematic cross-sectional view explaining a state in which capacitor elements of the present invention are laminated. As shown in FIG. 2, two capacitor elements 11, in which anode portion 5 and cathode portion 4 are formed by the separation by insulating portion 3, adhere at each cathode portion 4 with electroconductive adhesive 9 containing a silver paste or the like. After that, electroconductive adhesive 9 with which two capacitor elements 11 adhere is cured by heating to obtain a laminated body. The laminated body is mounted on board 46 having a required flatness. At this time, the porous layer in anode portion 5 is preliminary removed by a laser or the like. Thus, since anode portion 5 is in a state of a metal core of aluminum, it can easily be bent.

Also, since anode portion 5 including a metal core of aluminum is bent, there are effects that the stress to cathode portion 4 is relaxed, that the occurrence of a crack or the like inside cathode portion 4 is decreased, and that the leakage current is suppressed.

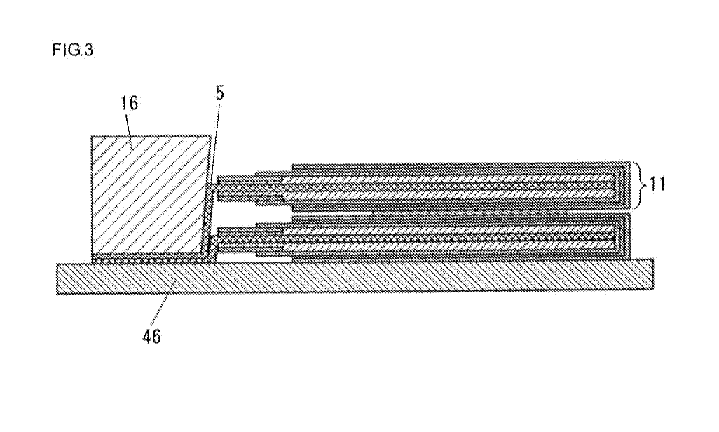

FIG. 3 is a schematic cross-sectional view explaining a state in which a forming of the capacitor element of the present invention is carried out. As shown in FIG. 3, forming jig 16 has a front edge with a predetermined angle. As the material, a metal such as stainless steel is used. A part of anode portion 5 between a terminal portion of anode portion 5 and insulating portion in two capacitor elements 11 mounted on board 46 is pressed by this forming jig 16 in the direction of the mounting surface of board 46 and is pressurized. In this way, a part of anode portion 5 can be bent in a shape of crank. Further, it is cut to a length so that the front edges of the anode portions 5 in the bent state are uniform and the welding can sufficiently be carried out. The force for pressing and the force for pressurizing are necessarily set to be a value so as not to damage anode portion 5.

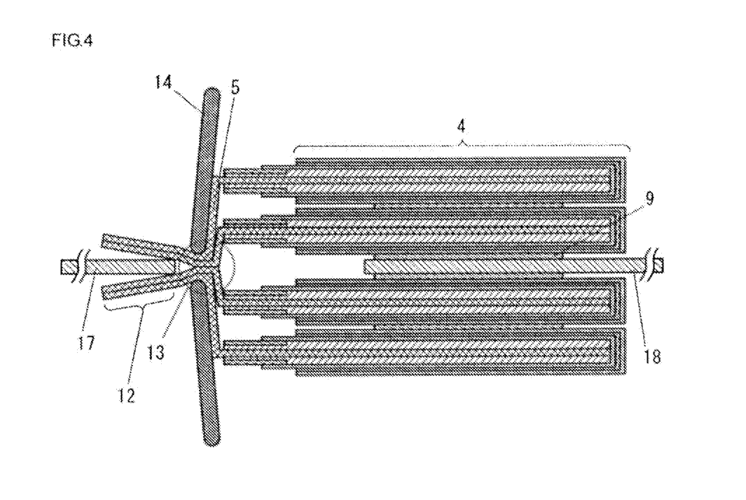

FIG. 4 is a schematic cross-sectional view explaining a state in which a part of an anode portion of the capacitor element of the present invention is gripped. As shown in FIG. 4, cathode portion 4 of one of two laminated bodies is connected to cathode terminal 18 with electroconductive adhesive 9 containing a silver paste or the like. In this state, a part of anode portion 5 between the terminal portion of anode portion 5 and the insulating portion, which is bent in a shape of crank, is gripped by using gripping member 14. The operation of gripping member 14 at the time of gripping anode portion 5 is preferably carried out in a state of tilting gripping member 14 to a side of the insulating portion in order to reduce the load at the time of contacting gripping member 14 to anode portion 5. In this way, bundled portion 13 in which anode portions 5 are bundled is formed. Also, the portion which is connected to anode terminal 17 in anode portion 5, namely welded portion 12, is placed so as to grip two connection surfaces of anode terminals 17.

Also, bundled portion 13 is preferably placed at a center in thickness direction of a laminated body in which the capacitor elements are laminated because the distance from the insulating portion in anode portion 5 can become uniform and because the deflection of the stress at the portion gripped by the gripping member or at the boundary portion with the insulating portion is suppressed when the ultrasonic welding is carried out.

Gripping member 14 may be a metal member to be used, but is preferably an elastic member in order to easily absorb the ultrasonic vibration at the time of the ultrasonic welding and not to conduct the vibration to anode portion 5 of the side of the insulating portion which is not welded. Specifically, silicone resins and urethane resins are included.

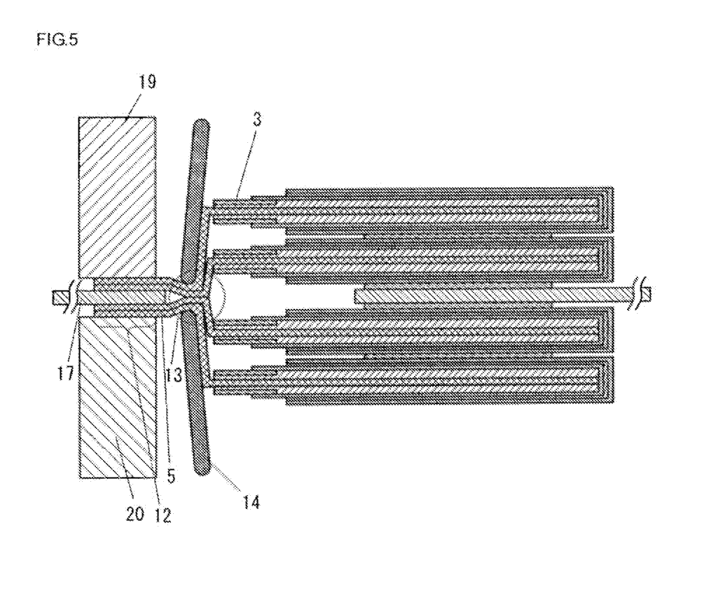

FIG. 5 is a schematic cross-sectional view explaining a state in which an ultrasonic welding is carried out in a state of gripping the part of an anode portion of the capacitor element of the present invention. As shown in FIG. 5, the ultrasonic welding is carried out in a state of gripping a part of anode portion 5 by using gripping member 14. Anvil 19 that is a received metal fitting of the ultrasonic welding and horn 20 that is a generation metal fitting of the ultrasonic vibration adhere to welded portion 12, and welded portion 12 is electrically connected to anode terminal 17. At this time, since a part of anode portion 5 that is bundled portion 13 is gripped by gripping member 14, the ultrasonic vibration hardly conducts to anode portion 5 in which the welding is not necessary and the occurrence of cutting off of anode portion 5 is suppressed. In particular, there is an effect for preventing cutting off of anode portion 5 of the side of insulating portion 3.

After carrying out the steps until FIG. 5, it is covered with an outer packaging of an insulating resin such as an epoxy resin to be able to obtain a solid electrolytic capacitor, in which the connectivity between the anode portion and the anode terminal is excellent, in which the anode portion of the side of the insulating portion is suppressed to be cut off, and in which the volumetric efficiency is improved.

### EXAMPLES

Hereinafter, the Examples of the present invention are explained in detail.

### Example 1

A porous layer was formed on the surface of an aluminum foil that is a valve action metal with a thickness of 150 μm by etching. The depth of the porous layer was set to be approximately 50 μm from the surface of the aluminum foil. Further, by using a metal mold, the aluminum foil was cut to a shape which included a moiety of the capacitor element, a moiety of the anode potion to be bent which was necessary in manufacturing, or the like. The dimension of the moiety becoming the capacitor element was set to be 6.0 mm in length×3.0 mm in width.

Subsequently, the moiety of the aluminum foil becoming the capacitor element was anodized by using an ammonium dihydrogen adipate aqueous solution with a concentration of 13% by mass, at an applied voltage of 50 V to form a dielectric oxide film for providing a dielectric layer.

Further, an epoxy resist resin was applied on the surface of the aluminum foil with the dielectric layer provided, namely an anode element body, in a band state to form an insulating portion by which the cathode portion and the anode portion were separated. The application of the resist resin was carried out by a screen printing. The dimension of the moiety for the cathode portion in the anode element body was set to be 4.0 mm in length×3.0 mm in width.

Then, a solid electrolyte layer containing a poly(3,4-ethylenedioxythiophene) was formed on the surface of the anode element body becoming the cathode portion by a chemical oxidation polymerization method. Further, a graphite layer and a silver paste layer were sequentially formed on the surface of the solid electrolyte layer.

After that, the dielectric layer and the porous layer formed on the surface of the anode element body on the side becoming an anode portion were removed by laser. A metal core of aluminum is exposed at the anode portion obtained by removing the dielectric layer and the porous layer, and can be easily bent. Also, the terminal portion of the anode portion except for the side of the insulating portion becomes a welded portion to be electrically connected to the anode terminal. In this way, the capacitor element of the present invention was produced.

Subsequently, the cathode portions of two capacitor elements were connected by an electroconductive adhesive containing a silver filler so that these were opposed. The electroconductive adhesive by which two capacitor elements were adhered was cured by heating to produce a laminated body. The laminated body was mounted on a board, and the anode portion was bent at two places by using a forming jig made of stainless steel, and the anode portion was cut in the state so that the length of the laminated body was 6 mm. By the same operations, another laminated body was produced. An electroconductive adhesive was applied on the cathode portion of one of both laminated bodies, and was sandwiched by the connecting surfaces of the cathode terminals to make a connection. The curing of the electroconductive adhesive was carried out at 180° C. for 20 min.

Then, after one terminal portion becoming the welded portion in the anode portion was placed so that the connecting surfaces of the anode terminals were sandwiched by the one terminal portion, a part of the bent anode portion was gripped by using a gripping member to bundle it.

In this state, an anvil and a horn of the ultrasonic welding adhered to the welded portion, and the anode terminal and the anode portion were electrically connected. By this welding step, a bundled portion which bundles a part of the anode portion between the insulating portion and the welded portion is formed. The gripping member used was made of stainless steel and had a thickness of 0.5 mm.

At the stage of finishing the ultrasonic welding, the evaluation of the welding state of the sample produced was carried out. The evaluation items were the cutting-off defective rate, the connecting defective rate and the leakage current.

The evaluation methods are as follows. At first, the electrostatic capacitance of the laminated body in which the welding was finished was measured, and the presence or the absence of the cutting-off defective and of the connecting defective was determined from the difference of the measured value and a theoretical design value of the electrostatic capacitance. Subsequently, the welded portion or the insulating portion of the laminated body at which the cutting-off defective or the connecting defective was thought to occur was observed with a magnifying glass to judge the cutting-off defective or the connecting defective. Also, the measurement of the leakage current (LC) was carried out. As the LC, the average value of the LC after 60 seconds at an applied voltage of 16 V was measured. The number of the evaluation was set to be 1000.

Finally, an outer packaging was provided on the sample in which the evaluation was finished by using a molding resin containing a glass filler by a molding machine to obtain the solid electrolytic capacitor of the present invention.

### Example 2

In Example 2, a silicone resin was used for the material of the gripping member, and the gripping member used had a thickness of 0.6 mm. Hence, the length of the cathode portion in the anode element body was set to be 3.9 mm. Except for these, a solid electrolytic capacitor was produced in the same manner as in Example 1.

### Comparative Example 1

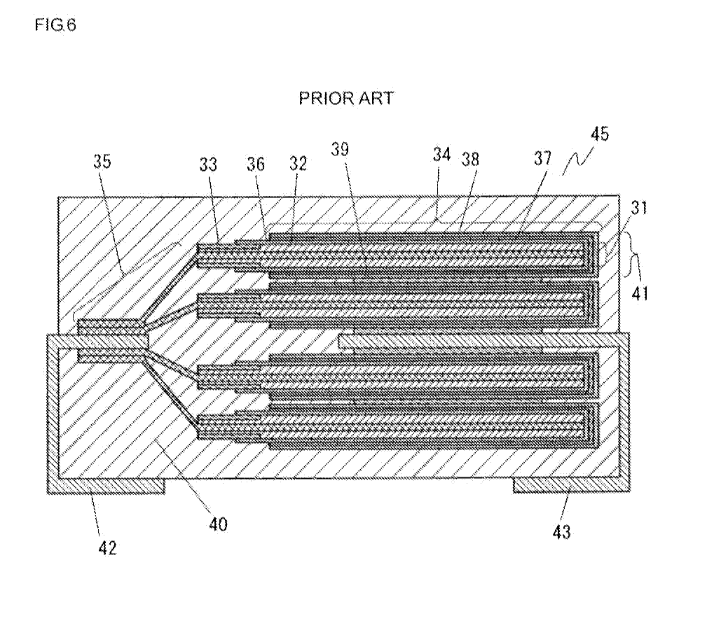

In Comparative Example 1, in order to make the structure be similar to that in the prior art, the ultrasonic welding was carried out without carrying out the forming in the anode portion and further without gripping a part of the anode portion, to obtain a solid electrolytic capacitor of FIG. 6. Since the forming was not carried out in Comparative Example 1, it was necessary to make a long distance between the welded portion and the insulating portion. Therefore, the length of the cathode portion in the anode element body was set to be 3.4 mm. Except for these conditions, the same operations as those of Example 1 were carried out.

### Comparative Example 2

In Comparative Example 2, although the forming in the anode portion was carried out in the same manner as in Examples 1 and 2, the ultrasonic welding was carried out without gripping a part of the anode portion to produce a solid electrolytic capacitor. Except for these conditions, the same operations as those of Example 1 were carried out.

### Comparative Example 3

In Comparative Example 3, although the forming in the anode portion was carried out in the same manner as in Examples 1 and 2, the ultrasonic welding was carried out without gripping a part of the anode portion with reducing the power of the ultrasonic welding to 80% with respect to that of Examples 1 and 2. Except for these conditions, the same operations as those of Example 1 were carried out.

The evaluation results of the samples in Examples and Comparative Examples are shown in TABLE 1. The defined items in the evaluation results are the cutting-off defective rate, the connecting defective rate and the LC. Also, in order to compare the volumetric efficiencies, the increased rate of the volumetric efficiency in the cathode portion of each Example with respect to that in the cathode portion of Comparative Example 1 were calculated and were shown.

TABLE 1
(n = 1000)

| | presence or | | | | volume |
|---|---|---|---|---|---|
| | absence of | | | | increasing |
| | gripping of | cutting-off | connecting | | rate of |
| | anode | defective | defective | LC | cathode |
| | portion | rate (%) | rate (%) | (μA) | portion (%) |
| Example 1 | presence | 3.0 | 0.0 | 0.13 | 18 |
| Example 2 | presence | 0.2 | 0.0 | 0.13 | 14 |
| Comparative | absence | 7.0 | 0.0 | 0.14 | 0 |
| Example 1 | | | | | |
| Comparative | absence | 32.0 | 0.0 | 0.14 | — |
| Example 2 | | | | | |
| Comparative | absence | 5.0 | 5.2 | 0.13 | — |
| Example 3 | | | | | |

As shown in TABLE 1, the cutting-off defective rate is decreased in Examples 1 and 2 of the present invention as compared with Comparative Examples 1 to 3.

Also, in Comparative Example 3, since the power of the ultrasonic welding was set to be 80% with respect to that of Examples 1 and 2, the cutting-off defective rate could be decreased as compared with Comparative Example 1. However, the connection became insufficient and the connecting defective was increased.

Also, it is found that the volume of the cathode portion in Examples 1 and 2 can be increased more than that in Comparative Example 1. In Comparative Examples 2 and 3 in which the forming is carried out, the spacing between the welded portion and the insulating portion can be narrowed and the volumetric efficiency can be increased more than that in Comparative Example 1. However, since the anode portion is not gripped, the cutting-off defective or the connecting defective is increased and it is difficult to adopt it.

The embodiment of the present invention was explained by using the Examples in the above, but the present invention is not limited to the Examples and includes an embodiment after changing a design variation within a scope of the present invention. That is, the present invention includes an embodiment after various changings or modifications which can be made by a person ordinarily skilled in the art.

What is claimed is:

1. A solid electrolytic capacitor, comprising plural capacitor elements which are laminated, in each of which an anode portion and a cathode portion are separated by an insulating portion, wherein the cathode portion is formed by forming a dielectric layer on a surface of a tabular valve action metal having a porous layer and by forming a solid electrolyte layer, a graphite layer and a silver paste layer in this order on a surface of the dielectric layer, and wherein the anode portion is formed by removing the dielectric layer and the porous layer, and
wherein the anode portion and the cathode portion are electrically connected to an anode terminal and a cathode terminal, respectively, and wherein the solid electrolytic capacitor comprises an outer packaging of an insulating material with which a whole area is covered,
wherein the anode portion comprises a welded portion at a terminal portion thereof which is connected to the anode terminal and a bundled portion which bundles a part of the anode portion between the welded portion and the insulating portion.

2. The solid electrolytic capacitor according to claim 1, wherein the bundled portion is placed at a center in thickness direction of a laminated body in which the capacitor elements are laminated.

3. The solid electrolytic capacitor according to claim 1, wherein the anode portion is formed by removing the dielectric layer and the porous layer from the tabular valve action metal having a porous layer on which a dielectric layer is formed.

4. A method for producing a solid electrolytic capacitor, comprising:
laminating plural capacitor elements, in each of which an anode portion and a cathode portion are separated by an insulating portion, wherein the cathode portion is formed by forming a dielectric layer on a surface of a tabular valve action metal having a porous layer and by forming a solid electrolyte layer, a graphite layer and a silver paste layer in this order on a surface of the dielectric layer, and wherein the anode portion is formed by removing the dielectric layer and the porous layer;
bending a part of the anode portion between a welded portion and the insulating portion in a laminating direction, wherein the anode portion comprises the welded portion at a terminal portion thereof which is connected to an anode terminal;
gripping the part of the anode portion in the laminating direction by using a gripping member to form a bundled portion;
connecting the welded portion to the anode terminal by an ultrasonic welding in a state of gripping the part of the anode portion;
connecting the cathode portion to a cathode terminal; and
covering the laminated capacitor elements, the anode terminal and the cathode terminal with an insulating resin to provide an outer packaging.

5. The method for producing a solid electrolytic capacitor according to claim 4, comprising placing the bundled portion at a center in thickness direction of a laminated body in which the capacitor elements are laminated.

6. The method for producing a solid electrolytic capacitor according to claim 4, wherein the gripping member comprises an elastic member.

7. The method for producing a solid electrolytic capacitor according to claim 4, wherein the anode portion is formed by removing the dielectric layer and the porous layer from the tabular valve action metal having a porous layer on which a dielectric layer is formed.

8. The method for producing a solid electrolytic capacitor according to claim 4, wherein, in connecting the welded portion to the anode terminal, the welded portion is placed so as to grip two connection surfaces of the anode terminal.

9. The method for producing a solid electrolytic capacitor according to claim 4, wherein, in forming the bundled portion, the part of the anode portion is gripped in a state of tilting the gripping member to a side of the insulating portion.
